(19) United States
(12) Patent Application Publication
(10) Pub. No.: US 2026/0300150 A1
(43) Pub. Date: Oct. 1, 2026

(54) REDUCING VOLTAGE DROOP IN VOLTAGE DOMAINS USING AN ACTIVATION SIGNAL

(71) Applicant: INTERNATIONAL BUSINESS MACHINES CORPORATION, ARMONK, NY (US)

(72) Inventors: MICHAEL SPERLING, POUGHKEEPSIE, NY (US); JENS DACI, POUGHKEEPSIE, NY (US)

(21) Appl. No.: 19/094,014

(22) Filed: Mar. 28, 2025

(51) Int. Cl. G06F 12/02; H02M 3/156

(52) U.S. Cl. CPC G06F 12/0223; H02M 3/156

(57) ABSTRACT

Reducing voltage droop in voltage domains using an activation signal including receiving, by a memory controller within an integrated circuit, an instruction to read a memory array; sending, by the memory controller, a read initiation signal to the memory array; and sending, by the memory controller, an activation signal to a voltage regulator associated with the memory array, wherein the activation signal activates the voltage regulator before reading the memory array is initiated by the read initiation signal.

### BACKGROUND

The present disclosure relates to methods, apparatus, and products for reducing voltage droop in voltage domains using an activation signal.

### SUMMARY

According to embodiments of the present disclosure, various methods, apparatus and products for reducing voltage droop in voltage domains using an activation signal are described herein. In some aspects, reducing voltage droop in voltage domains using an activation signal includes receiving, by a memory controller within an integrated circuit, an instruction to read a memory array; sending, by the memory controller, a read initiation signal to the memory array; and sending, by the memory controller, an activation signal to a voltage regulator associated with the memory array, wherein the activation signal activates the voltage regulator before reading the memory array is initiated by the read initiation signal.

### BRIEF DESCRIPTION OF THE DRAWINGS

FIG. 1 sets forth an example computing environment according to aspects of the present disclosure.

FIG. 2 sets forth an example integrated circuit for reducing voltage droop in voltage domains using an activation signal according to aspects of the present disclosure.

FIG. 3 sets forth an example voltage regulator for reducing voltage droop in voltage domains using an activation signal according to aspects of the present disclosure.

FIG. 4 sets forth a flowchart of an example method for reducing voltage droop in voltage domains using an activation signal according to aspects of the present disclosure.

### DETAILED DESCRIPTION

Voltage regulators are placed in integrated circuits to maintain a particular voltage across a number of different loads. As different loads increase and decrease voltage usage, the voltage within the voltage regulated domain may waiver temporarily (i.e., droop) as the voltage regulators adjust. This may have a measurable effect on memory array reads. The present disclosure describes a method and circuitry to reduce droop within memory systems.

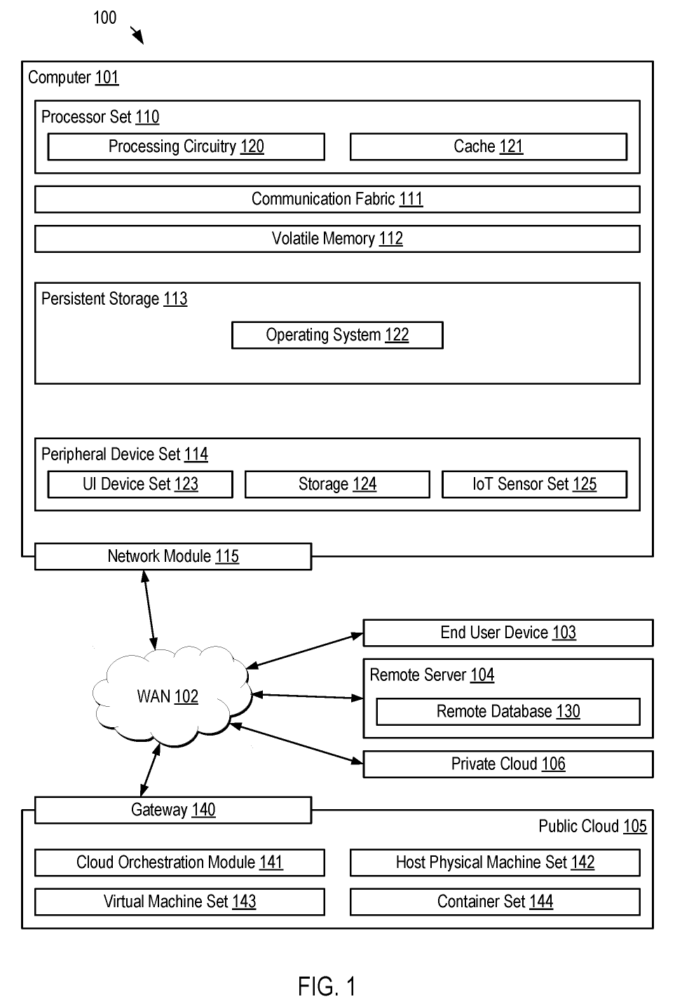

With reference now to FIG. 1, FIG. 1 sets forth an example computing environment according to aspects of the present disclosure. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

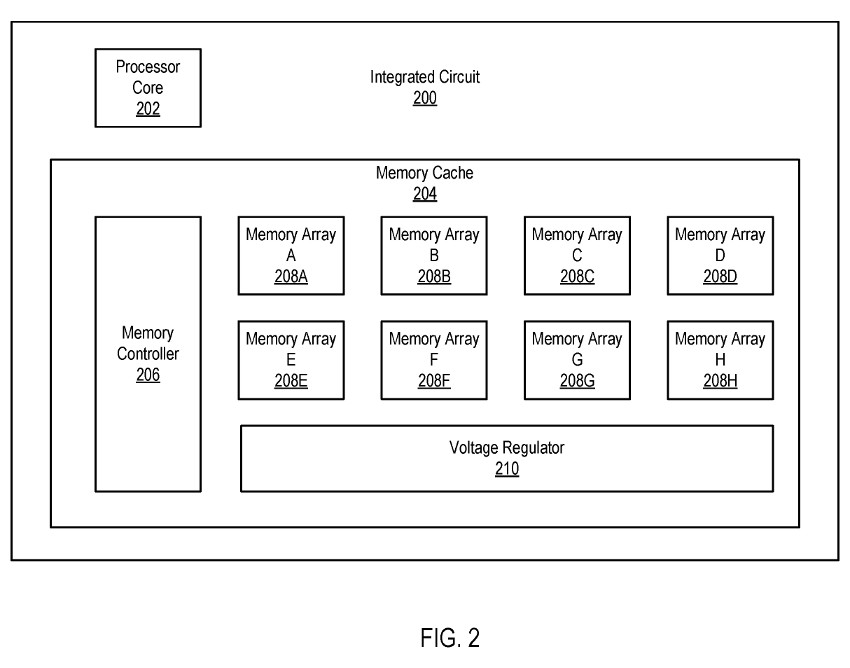

FIG. 2 sets forth an example integrated circuit for reducing voltage droop in voltage domains using an activation signal according to aspects of the present disclosure. As shown in FIG. 2, the integrated circuit 200 includes a processor core 202 and a memory cache 204. The memory cache 204 includes a memory controller 206, multiple memory arrays (memory array A 208A, memory array B 208B, memory array C 208C, memory array D 208D, memory array E 208E, memory array F 208F, memory array G 208G, memory array H 208H), and a voltage regulator 210.

The integrated circuit 200 is a collection of electronic components and interconnections etched into a semiconductor material. The integrated circuit 200 may include, for example, a processing unit, data storage, power management, or input and output functions. The integrated circuit 200 may include one or more voltage domains. A voltage domain is a group of electronic components that share a voltage supply.

The processor core 202 is part of the processing circuitry and may be one of many processor cores within the processing unit on the integrated circuit 200. The processor core 202 executes instructions and sends signals to other circuitry on the integrated circuit 200. When data is to be retrieved from the memory cache 204, the processor core 202 may send a signal to the memory controller 206 to initiate the data read.

The memory cache 204 is a collection of memory arrays (memory array A 208A, memory array B 208B, memory array C 208C, memory array D 208D, memory array E 208E, memory array F 208F, memory array G 208G, memory array H 208H) and a memory controller 206 used to store and retrieve data on the integrated circuit 200. The memory controller 206 is circuitry to manage the memory arrays and service requests from the processor core 202 to store and retrieve data from within the memory array. Each memory array (memory array A 208A, memory array B 208B, memory array C 208C, memory array D 208D, memory array E 208E, memory array F 208F, memory array G 208G, memory array H 208H) is a structure used to store data in the memory. The memory arrays receive instructions from the memory controller, including read initiation signals. A read initiation signal is a signal from the memory controller instructing the memory array to prepare to transmit data stored on the particular memory array.

There exists communication links between the elements shown in FIG. 2 that are not presented in the diagram. Such communication links facilitate, for example, receiving read instructions and initiating reads from one or more memory arrays. There also exists power links between the elements shown in FIG. 2 that are not presented in the diagram. Such power links provide voltage across the circuitry that makes up the memory cache 204 and processor core 202.

The voltage regulator 210 is a circuit that is designed to maintain a constant output voltage level as operating conditions change over time. That is, the voltage regulator receives an input voltage and automatically maintains a constant voltage level on one or more output terminals. There are several types of voltage regulators such as, for example, switching regulators, linear regulators, and cascaded regulators that may include both switching and linear regulators in a cascaded architecture. One particular type of linear regulator that may be used is a low-dropout (LDO) regulator. An LDO regulator is a linear voltage regulator that may regulate the output voltage even when the supply voltage is close to the output voltage. That is, the LDO regulator may maintain voltage regulation with small differences between supply voltage and load voltage. Another type of voltage regulator is a buck switching regulator (e.g., a step-down regulator circuit). The buck switching regulator is a type of switch mode power supply circuit designed to efficiently reduce voltage from a higher voltage to a lower voltage. Multiple voltage regulators may be distributed across a voltage domain to regulate the voltage across different loads.

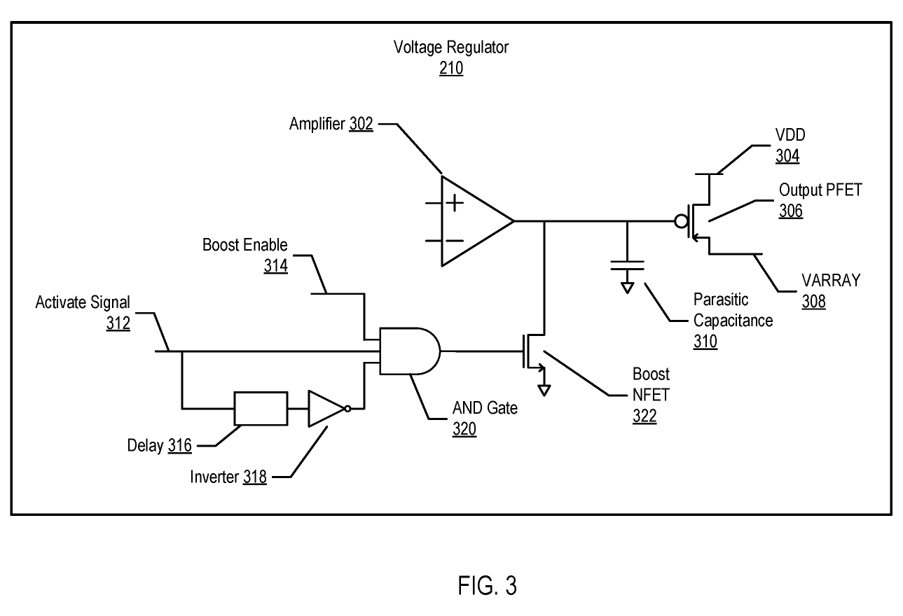

FIG. 3 sets forth an example voltage regulator for reducing voltage droop in voltage domains using an activation signal according to aspects of the present disclosure. As shown in FIG. 3, the voltage regulator 210 includes an amplifier 302, an output PFET 306, and a parasitic capacitance 310. The amplifier 302 acts as a control for the voltage across the gate of the output PFET 306. The output PFET 306 regulates the voltage from the supply voltage (VDD 304) to the output voltage (VARRAY) 308.

The voltage regulator 210 also includes circuitry for receiving an activation signal and using the activation signal to reduce droop on the voltage output of the voltage regulator 210. This boost circuitry includes the boost NFET 322, the AND gate 320, the delay 316, and the inverter 318. The boost circuitry receives an activate signal 312 from the memory controller. The activate signal is sent on one input of the AND gate 320. The activate signal 312 is also sent through a delay 316 and an inverter 318 before being sent on another input of the AND gate 320. The two inputs on the AND gate 320 create a pulse on the output of the AND gate 320 such that the boost NFET 322 temporarily pulls the voltage on the voltage regulator down, causing a greater voltage to flow across the output PFET 306.

The boost circuitry optionally includes a boost enable signal 314 on a third input to the AND gate 320. The boost enable signal 314 allows the memory controller (or other element within or external to the integrated circuit) to enable or disable the boost circuitry. By sending a high signal on the boost enable signal 314, a third input to the AND gate 320 may be activated to enable the pulse to be generated and sent to the boost NFET 322. If there is no boost enable signal 314 line, then the AND gate 320 may only include two inputs.

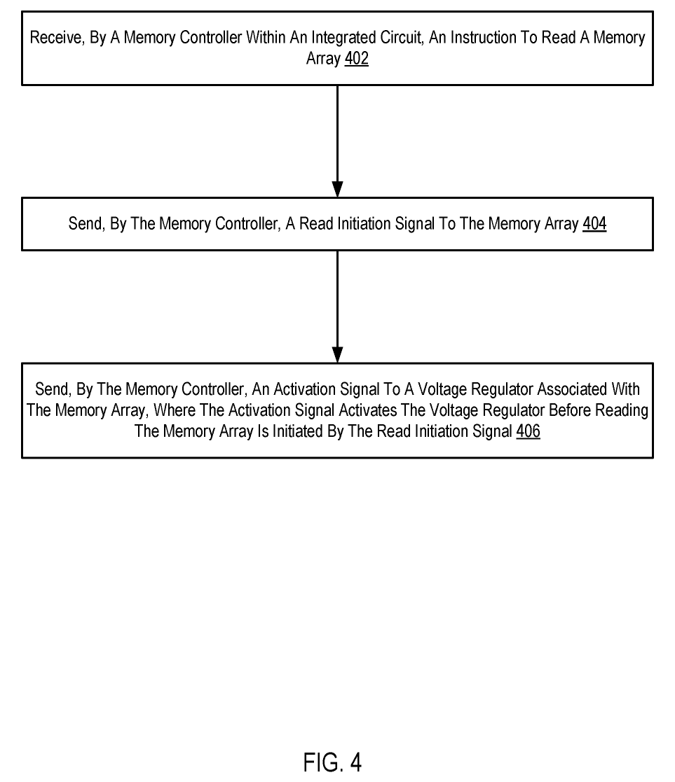

FIG. 4 sets forth a flowchart of an example method for reducing voltage droop in voltage domains using an activation signal according to aspects of the present disclosure. The method of FIG. 4 describes using an activation signal to prepare the voltage regulator for reading a memory array and preventing droop (a temporary drop in voltage) caused by initiating he memory read. The method of FIG. 4 includes receiving 402, by a memory controller within an integrated circuit, an instruction to read a memory array. In one or more embodiments, receiving 402 an instruction to read a memory array is carried out by the memory controller detecting an incoming message targeting a particular memory array under the control of the memory controller. The instruction to read the memory array may be received from a processor core of the integrated circuit. Alternatively, the instruction may be received from another element inside or external to the integrated circuit.

The instruction to read the memory array may include information to identify the particular memory array targeted. For example, the instruction may include an absolute or relative address of the memory array itself. Further, multiple memory arrays may be identified in the instruction if the read requires data from more than one memory array. The instruction may also include an address of the data within the memory array or memory arrays. The instruction may further include an identifier of the location to which the read data is to be transmitted. Specifically, the instruction may include an address of a cache or bus to which, or upon which, the data is to be sent.

Once the memory controller receives the instruction to read the memory array, the memory controller may then parse the instruction and locate the targeted memory array. This may include translating the identifier of the memory array to an address system used by the memory controller. For example, the memory controller may decode the address received in the instruction to read to determine row and column within the memory array that contains the requested data.

The method of FIG. 4 also includes sending 404, by the memory controller, a read initiation signal to the memory array. In one or more embodiments, sending 404 a read initiation signal to the memory array is carried out by the memory controller activating the location within the memory array. Specifically, the memory controller may activate a portion of the memory array (e.g., a row) by raising the voltage on that portion. This will connect the storage capacitors within the memory array to the bitlines.

The method of FIG. 4 also includes sending 406, by the memory controller, an activation signal to a voltage regulator associated with the memory array, wherein the activation signal activates the voltage regulator before reading the memory array is initiated by the read initiation signal. In one or more embodiments, sending 406 an activation signal to a voltage regulator associated with the memory array is carried out by using the activation signal to increase the voltage across one or more voltage regulators that regulate the voltage used by the targeted memory array.

Using the activation signal to increase the voltage across one or more voltage regulators may include increasing the voltage across a transistor of the voltage regulator. This may include sending a high signal to an input of a boost NFET coupled to the voltage regulator. Further circuitry (e.g. boost circuitry) may be used to create a pulse that sends a short high signal to the boost NFET. Using such circuitry, the activation signal causes a pulse that temporality increases the voltage across the transistor of the voltage regulator.

Such boost circuitry may include the ability to enable and disable the voltage boost and droop prevention. For example, if the integrated circuit is in a state in which using the activation signal is undesirable or inefficient, the use of the activation signal may be disabled using a separate signal (e.g., a boost enable signal). Such a signal may be use in conjunction with a AND gate to only implement the activation signal in the voltage regulator(s) if the boost enable signal is high.

The instruction to read the memory array my trigger the sending of the read initiation signal and the activation signal. In other words, receiving the instruction to read the memory array may cause the read initiation signal and the activation signal to be transmitted to their respective targets. The read initiation signal and the activation signal may be sent concurrently. Specifically, the read initiation signal and the activation signal may be sent out from the memory controller simultaneously or so close together in time as to be effectively simultaneous.

Sending 404 a read initiation signal to the memory array and sending 406 an activation signal to a voltage regulator associated with the targeted memory array is performed such that the activation signal activates the voltage regulator before reading the memory array is initiated by the read initiation signal. Specifically, the increase in voltage across one or more voltage regulators caused by the activation signal occurs chronologically prior to the commencing of the memory array read caused by the read initiation signal. By increasing the voltage across one or more voltage regulators, the activation signal prevents voltage droop on the voltage supplied by the voltage regulator that would be caused by the initiation of the memory array read.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, by a memory controller within an integrated circuit, an instruction to read a memory array;
sending, by the memory controller, a read initiation signal to the memory array; and
sending, by the memory controller, an activation signal to a voltage regulator associated with the memory array, wherein the activation signal activates the voltage regulator before reading the memory array is initiated by the read initiation signal.

2. The method of claim 1, wherein the instruction to read the memory array is received from a processor core of the integrated circuit.

3. The method of claim 1, wherein the activation signal causes an increase in voltage across a transistor of the voltage regulator.

4. The method of claim 3, wherein the activation signal causes a pulse that temporality increases the voltage across the transistor of the voltage regulator.

5. The method of claim 1, wherein the activation signal prevents voltage droop on a voltage supplied by the voltage regulator.

6. The method of claim 1, wherein the read initiation signal and the activation signal are sent concurrently.

7. The method of claim 1, wherein the voltage regulator comprises circuitry to enable and disable the activation signal.

8. The method of claim 1, wherein the voltage regulator is one of a plurality of voltage regulators within a voltage domain.

9. The method of claim 1, wherein the voltage regulator comprises an amplifier and a transistor.

10. The method of claim 1, wherein the memory controller is within a memory cache.

11. An integrated circuit comprising:
a processor core;
a plurality of memory arrays; and
a memory controller configured for:
receiving an instruction to read a memory array of the plurality of memory arrays;
sending a read initiation signal to the memory array; and
sending an activation signal to a voltage regulator associated with the memory array, wherein the activation signal activates the voltage regulator before reading the memory array is initiated by the read initiation signal.

12. The integrated circuit of claim 11, wherein the instruction to read the memory array is received from the processor core of the integrated circuit.

13. The integrated circuit of claim 11, wherein the activation signal causes an increase in voltage across a transistor of the voltage regulator.

14. The integrated circuit of claim 13, wherein the activation signal causes a pulse that temporality increases the voltage across the transistor of the voltage regulator.

15. The integrated circuit of claim 11, wherein the activation signal prevents voltage droop on a voltage supplied by the voltage regulator.

16. The integrated circuit of claim 11, wherein the read initiation signal and the activation signal are sent concurrently.

17. The integrated circuit of claim 11, wherein the voltage regulator comprises circuitry to enable and disable the activation signal.

18. The integrated circuit of claim 11, wherein the voltage regulator is one of a plurality of voltage regulators within a voltage domain.

19. The integrated circuit of claim 11, wherein the voltage regulator comprises an amplifier and a transistor.

20. A computer program product comprising:
one or more computer-readable storage media; and
program instructions stored on the one or more computer-readable storage media to perform operations comprising:
receiving, by a memory controller within an integrated circuit, an instruction to read a memory array;
sending, by the memory controller, a read initiation signal to the memory array; and
sending, by the memory controller, an activation signal to a voltage regulator associated with the memory array, wherein the activation signal activates the voltage regulator before reading the memory array is initiated by the read initiation signal.
